(19) United States
(12) Patent Application Publication
(10) Pub. No.: US 2015/0348158 A1
(43) Pub. Date: Dec. 3, 2015

(54) REPEAT-ORDERING SYSTEMS AND METHODS

(71) Applicant: EyeOTee, Inc., Kirkland, WA (US)

(72) Inventors: Sharon BESSER, Pardes Hana - Karkur (IL); Ilya MINKIN, Los Altos, CA (US); Ran NAHMIAS, Kirkland, WA (US)

(21) Appl. No.: 14/723,112

(22) Filed: May 27, 2015

Related U.S. Application Data
(60) Provisional application No. 62/003,478, filed on May 27, 2014.

(51) Int. Cl. G06Q 30/06; H04W 4/12

(52) U.S. Cl. CPC G06Q 30/0625; H04W 4/12

(57) ABSTRACT

A repeat-ordering service may facilitate convenient “one-touch” ordering of a particular good and/or service. In one embodiment, a special-purpose signaling device may be configured to be associated with a fulfillment profile describing one or more particular goods and/or services, as well as payment and fulfillment information. Such a signaling device may communicate wirelessly with a repeat-ordering service and may be physically configured to be placed in a locale that is near to where a consumer would typically become aware of a need for the particular goods and/or services.

### CROSS-REFERENCE TO RELATED APPLICATIONS

This application claims the benefit of priority to Provisional Patent Application No. 62/003,478; filed May 27, 2014 under Attorney Docket No. EYEO-2014002; titled REPEAT-ORDERING SYSTEMS AND METHODS; and naming inventors Sharon BESSER et al. The above-cited application is hereby incorporated by reference, in its entirety, for all purposes.

### FIELD

This disclosure is directed to the field of electronic commerce, and more particularly to providing systems and methods for facilitating repeat-orders of particular goods and/or services.

### BACKGROUND

Individuals, entities, and others who consume good and/or service often order the same good and/or service repeatedly, especially consumable goods and/or services. For example, pet owners may repeatedly order a particular quantity of a particular type of pet food and/or pet litter; new parents may repeatedly order a particular quantity of a particular type of diaper; those who use dietary supplements may repeatedly order a particular quantity of a particular type of nutritional supplement; some consumers may repeatedly order a particular quantity of a particular type of soap, shampoo, or similar body-care product; and so on. A consumer often desires to never run out of such types of consumable goods and/or services.

In some cases, a consumer may simply visit a store and/or place an order for the consumable good and/or service when the consumer's local inventory is running low. However, a frequent problem is that the consumer may not be in an immediate position to initiate an order at the place and/or time when the consumer becomes aware that additional supplies are needed. For example, some consumers may become aware that they are running low on shampoo while in the shower, but they may often forget this need by the time they are at a computer or otherwise in a position to place an order from a shampoo merchant.

Moreover, even when a consumer is able to remember that he or she needs to re-order a given good and/or service, the typical e-commerce user experience requires many steps, such as accessing a computing device, entering authentication credentials, searching for the good and/or service, adding the good and/or service to a shopping cart, entering payment information, entering shipment information, and the like.

Various subscription services exist to provide certain types of goods and/or services on a periodic basis. Typically, a consumer will set up a subscription configured to periodically provide a predetermined quantity of one or more goods and/or services on a fixed schedule, such as once per month, once every N weeks, or the like.

However, while subscription periods are fixed, the consumer's rate of consumption of many consumable goods may vary over time. As a result, it can be difficult or impossible for a consumer to determine a fixed subscription schedule that will maintain an acceptable local inventory of the good and/or service at all times.

### BRIEF DESCRIPTION OF THE DRAWINGS

To easily identify the discussion of any particular element or act, the most significant digit or digits in a reference number refer to the figure number in which that element is first introduced.

FIG. 1 illustrates a simplified repeat-ordering system in which repeat-ordering-service server, configuration device, vendor device, dedicated signaling device, and signaling ‘soft’ client are connected to network.

FIG. 2 illustrates several components of an exemplary signaling device in accordance with one embodiment.

FIG. 3 illustrates an exemplary series of communications between repeat-ordering-service server, vendor device, signaling device, and configuration device in accordance with one embodiment.

FIG. 4 illustrates a configuration routine for configuring a given signaling switch of a given signaling device to initiate fulfillment of particular goods and/or services, such as may be performed by a repeat-ordering-service server in accordance with one embodiment.

FIG. 5 illustrates a fulfillment-message routine for handling a fulfillment-request message, such as may be performed by a repeat-ordering-service server in accordance with one embodiment.

FIG. 6 illustrates a fulfillment subroutine for initiating fulfillment of a given good and/or service described in a given fulfillment profile, such as may be performed by a repeat-ordering-service server in accordance with one embodiment.

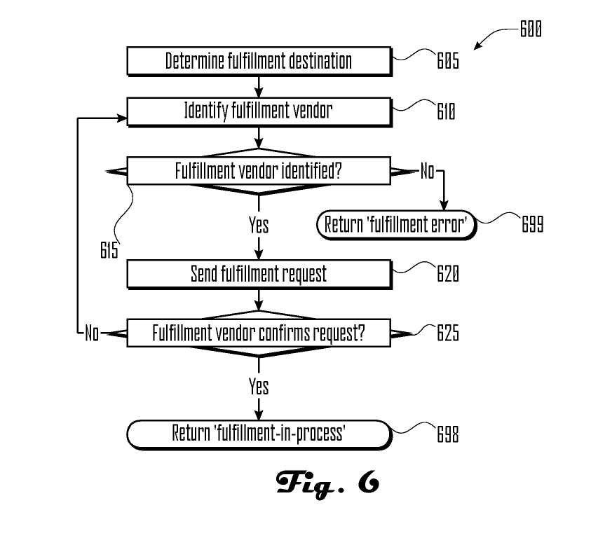

FIG. 7 illustrates a signaling routine for sending a fulfillment-request message to a repeat-ordering service, such as may be performed by a signaling device in accordance with one embodiment.

FIG. 8 illustrates a switch-handling subroutine for handling activation of a signaling switch, such as may be performed by a signaling device in accordance with one embodiment.

FIG. 9 illustrates a feedback-message-handling subroutine for handling a received feedback message, such as may be performed by a signaling device in accordance with one embodiment.

FIG. 10 illustrates a timer-expiration subroutine for handling an expired timer, such as may be performed by a signaling device in accordance with one embodiment.

FIG. 11 illustrates several components of an exemplary repeat-ordering-service server in accordance with one embodiment.

### DETAILED DESCRIPTION

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

In various embodiments, as discussed herein, a repeat-ordering service may facilitate convenient “one-touch” ordering of a particular good and/or service. Briefly, in one embodiment, a special-purpose signaling device may be configured to be associated with a fulfillment profile describing one or more particular goods and/or services, as well as payment and fulfillment information. Such a signaling device may communicate wirelessly with a repeat-ordering service and may be physically configured to be placed in a locale that is near to where a consumer would typically become aware of a need for the particular goods and/or services.

For example, in one embodiment, a consumer may place in a baby changing room a special-purpose signaling device configured to initiate an order for a predetermined quantity of diapers when the consumer activates a button or other switch on the signaling device. In other embodiments, a signaling device configured to initiate an order for a predetermined quantity of cat litter may be placed on or near a litter box. Many other variations are possible.

In such embodiments, a consumer may create essentially a “subscription-on-demand” service that is not tied to a fixed schedule, but that enables almost effortless ordering of a particular consumable at the time and place when/where the consumer is most likely to be thinking about the need to reorder that consumable.

In some embodiments, a vendor and/or manufacturer may provide to its customers signaling devices that are pre-configured to initiate orders for the vendor's products. For example, in one embodiment, a pizza restaurant may provide to customers in its delivery area signaling devices that are configured to initiate deliveries of, as one example, pepperoni pizzas when the customers activate their signaling devices.

Many additional details and variations are described more fully below.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

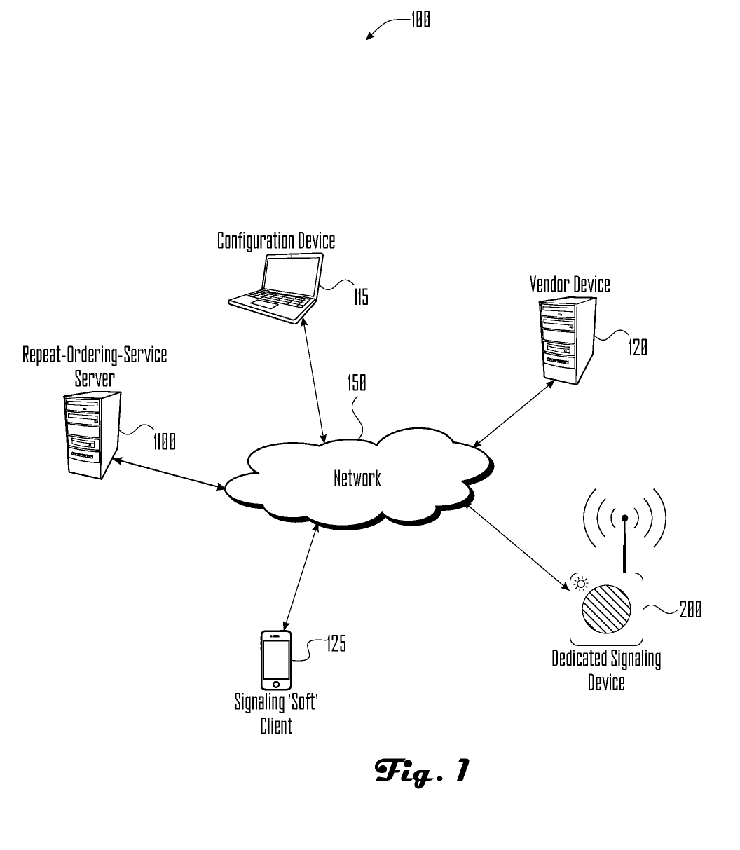

FIG. 1 illustrates a simplified repeat-ordering system in which repeat-ordering-service server 1100, configuration device 115, vendor device 120, dedicated signaling device 200, and signaling ‘soft’ client 125 are connected to network 150.

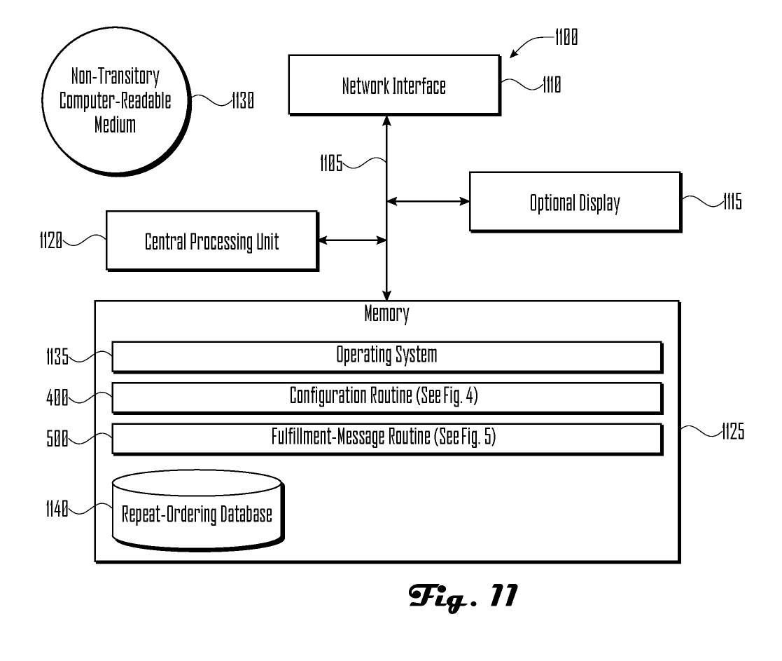

Repeat-ordering-service server 1100 (see FIG. 11, discussed below) represents a provider of repeat-ordering services, such as described more fully below.

In various embodiments, network 150 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, network 150 may also include a voice network that conveys not only voice communications, but also non-voice data such as Short Message Service (“SMS”) messages, as well as data communicated via various cellular data communication protocols, and the like.

In various embodiments, configuration device 115 may include desktop PCs, mobile phones, laptops, tablets, wearable computers, or other computing devices that are capable of connecting to network 150 and communicating with repeat-ordering-service server 1100, such as described herein. In some embodiments, configuration device 115 may be operated by a consumer, who may configure one or both of dedicated signaling device 200 and signaling ‘soft’ client 125 to suit his or her own needs. In other embodiments, configuration device 115 may be operated by a provider of a particular good and/or service, which may pre-configure dedicated signaling device 200 and/or signaling ‘soft’ client 125 before the signaling devices are provided to a consumer.

In various embodiments, vendor device 120 may include desktop PCs, mobile phones, laptops, tablets, wearable computers, or other computing devices that are capable of connecting to network 150 and accepting messages to initiate an order fulfillment, such as described herein.

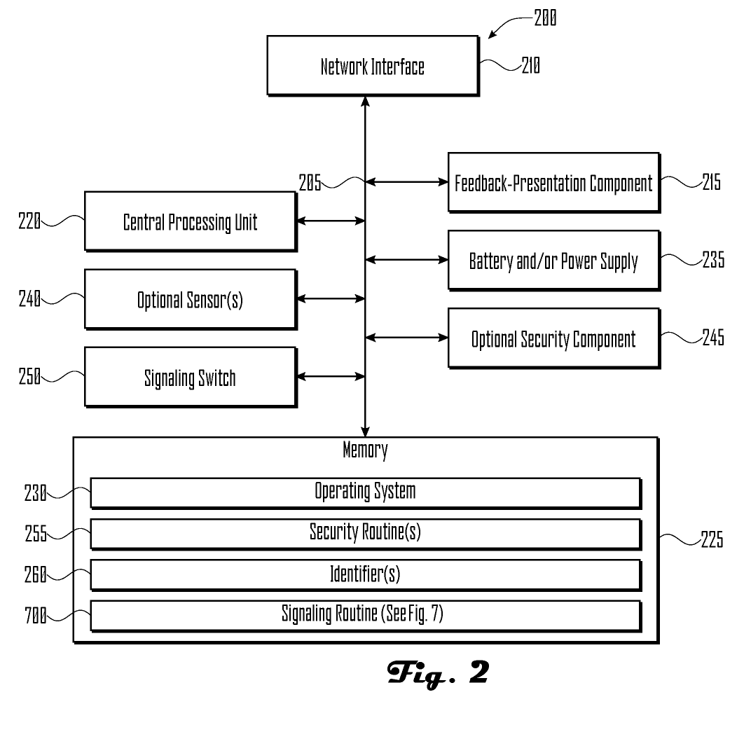

In various embodiments, dedicated signaling device 200 may include a dedicated-hardware variant of signaling device 200 (see FIG. 2, discussed below) that communicates wirelessly with repeat-ordering-service server 1100 via SMS messages or other similar communication protocol over a voice-portion of network 150. In some embodiments, using a SMS or similar communication pathway may enable dedicated signaling device 200 to be delivered to a consumer in a state that requires little or no configuration by the consumer before dedicated signaling device 200 can access network 150 and communicate with repeat-ordering-service server 1100.

In other embodiments, such as when dedicated signaling device 200 communicates via a consumer's wireless local network, the consumer may be required to provide various configuration/authentication details and/or credentials in order to access network 150.

In various embodiments, signaling ‘soft’ client 125 may include a mobile phone or other general-purpose computing devices (e.g, desktop PCs, laptops, tablets, wearable computers, or other computing devices) that may be temporarily configured via software (e.g., by executing a special-purpose application) and/or via accessory hardware (e.g., a peripheral sensor, signaling switch, or the like) to function similarly to signaling device 200 (see FIG. 2, discussed below).

In various embodiments, additional infrastructure (e.g., short message service centers, cell sites, routers, gateways, firewalls, and the like), as well as additional devices may be present. Further, in some embodiments, the functions described as being provided by some or all of repeat-ordering-service server 1100 and vendor device 120 may be implemented via various combinations of physical and/or logical devices.

However, it is not necessary to show such infrastructure and implementation details in FIG. 1 in order to describe an illustrative embodiment.

FIG. 2 illustrates several components of an exemplary signaling device in accordance with one embodiment. In some embodiments, signaling device 200 may include many more components than those shown in FIG. 2. However, it is not necessary that all of these generally conventional components be shown in order to disclose an illustrative embodiment.

Signaling device 200 includes a bus 205 interconnecting several components including a network interface 210, a feedback-presentation component 215, a central processing unit 220, a memory 225, a battery and/or power supply 235, one or more optional sensors 240, an optional security component 245, and a signaling switch 250.

In some embodiments, network interface 210 may include a radio transceiver for communicating with a cell site and/or other wireless network access point. In various embodiments, such a radio transceiver may be compatible with any suitable cellular communication protocols and/or standards, such as the Global System for Mobile Communications (“GSM”) standard, code division multiple access (“CDMA”), Long-Term Evolution (“LTE”) wireless standard, and the like.

Network interface 210 is configured to transmit messages to repeat-ordering-service server 1100 via an appropriate protocol when signaling switch 250 is activated.

Feedback-presentation component 215 is configured for presenting feedback messages from repeat-ordering-service server 1100, as discussed below.

In some embodiments, feedback-presentation component 215 may include a visual presentation component that may be as simple as one or more light-emitting diodes (“LEDs”) and/or a segment display, or as complex as a electronic visual display such as a liquid-crystal display (“LCD”) panel; an electronic paper and/or electronic ink display; or the like.

In other embodiments, feedback-presentation component 215 may include an auditory presentation component such as an electroacoustic transducer and/or a mechanical, electromechanical, or piezoelectric buzzer or beeper.

Memory 225 generally comprises a random access memory (“RAM”) and permanent non-transitory storage device, such as a solid-state drive, erasable programmable read only memory (“EPROM”), Electrically Erasable Programmable Read-Only Memory (“EEPROM”), flash memory, and/or a subscriber identification module (SIM), Universal Integrated Circuit Card (“UICC”), CDMA Subscriber Identity Module (“CSIM”), Universal Subscriber Identity Module (“USIM”), or the like.

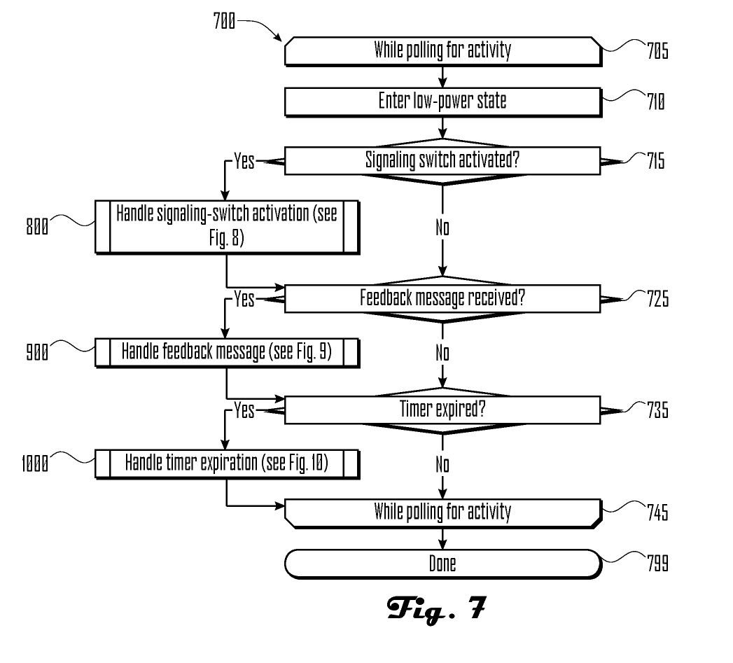

Memory 225 stores program code for a signaling routine 700 for sending a fulfillment-request message to a repeat-ordering service (see FIG. 7, discussed below). In addition, the memory 225 also stores an operating system 230, one or more security routines 255, and one or more identifiers 260.

Battery and/or power supply 235 supplies electrical power for operating signaling device 200. In some embodiments, battery and/or power supply 235 may include components and circuitry suitable for wired and/or wireless power transmission from an external power source. In some embodiments, battery and/or power supply 235 may include an electricity-generating component such as a photovoltaic module, as well as power management components for maximizing battery life. In some embodiments, a ‘standby’ battery may power a switch or relay that disconnects a main battery from bus 1105 when signaling device 200 is in a low-power or ‘standby’ mode.

In some embodiments, signaling device 200 may include one or more optional sensors 240 that may be configured to provide data from which various aspects of a fulfillment-request message may be determined, as discussed further below. For example, in some embodiments, optional sensor(s) 240 may include a sensor component that provide data about signaling device's 200 position and/or location in the world and/or within a physical space. In some embodiments, such positioning data may be used to help determine fulfillment data, such as a delivery location. For example, some embodiments may include a Global Positioning System (“GPS”) module, a low-power indoor positioning system (“IPS”) module, or other proximity-sensing and/or positioning module.

Other embodiments may include sensors for determining various other aspects of the environment in which signaling device 200 is positioned, such as a temperature sensor, a microphone, a photosensor and/or photodetector, a motion sensor, or the like.

In some embodiments, signaling device 200 may include an optional security component 245, such as a hardware random number generator that generates random numbers from a physical process, a product validation device, or the like.

In various embodiments, signaling device 200 includes one or more uniquely identifiable signaling switches 250. In some embodiments, a signaling switch 250 may include an electrical component that can selectively break an electrical circuit, such as a pushbutton mechanism. Some embodiments may include several such signaling switches. In some embodiments, signaling switch 250 may also include a physical selector component such as a rotary switch that may be used to select among different identifiers when a single pushbutton or similar switch is activated.

In other embodiments, signaling switch 250 may include a logical selector component that may cause different messages to be sent when signaling switch 250 is activated in different ways. For example, in one embodiment, signaling switch 250 may include a pushbutton configured to send a first message upon a single momentary activation (single-push), to send a second message upon a double momentary activation (double-push), and to send a third message upon a single activation that exceeds a predetermined length of time (long push).

In some embodiments, memory 225 also stores one or more security routines 255 that may be used to encrypt, authenticate, and/or otherwise secure some or all communications between signaling device 200 and a repeat-ordering service, as described further below. In some embodiments, security routine(s) 255 may utilize random numbers provided by optional security component 245 (if present).

For example, in one embodiment, some or all outgoing messages from signaling device 200 may be signed by a private key. Further, in some embodiments, some or all outgoing messages from signaling device 200 to repeat-ordering-service server 1100 (see FIG. 11, discussed below) may include a ‘one time password’ according to a scheme similar to the following.

During provisioning and/or configuration, repeat-ordering-service server 1100 provides a seed value to signaling device 200, which uses the seed to generate a sequence of A numbers n1 . . . nA. Subsequently, signaling device 200 may include nX into some or all of the messages it sends staring from nA and going backwards. When repeat-ordering-service server 1100 detects nX close to n1, repeat-ordering-service server 1100 sends a new seed to signaling device 200. Other embodiments may employ other suitable message-security schemes.

Memory 225 also stores one or more identifiers 260, some or all of which may be Globally Unique Identifiers (“GUIDs”) or similar unique identifiers.

In some embodiments, one or more identifiers 260 may include one or more signaling-device identifiers, such as an International Mobile Station Equipment Identity (“IMEI”), a media access control address (“MAC address”), and/or other arbitrary GUID. In some embodiments, each signaling switch and/or signaling switch combination of signaling switch 250 may also be associated with an identifier.

In some embodiments, one or more identifiers 260 may also include subscriber-related identifiers such as a integrated circuit card identifier (“ICCID”), an international mobile subscriber identity (“IMSI”), and/or an mobile subscription identification number (“MSIN”).

In various embodiments, as discussed below, some or all of such identifiers may be used to determine one or more message signatures associated with signaling device 200.

In some embodiments, some or all of such identifiers may be stored in a non-erasable, nonvolatile component of memory 225.

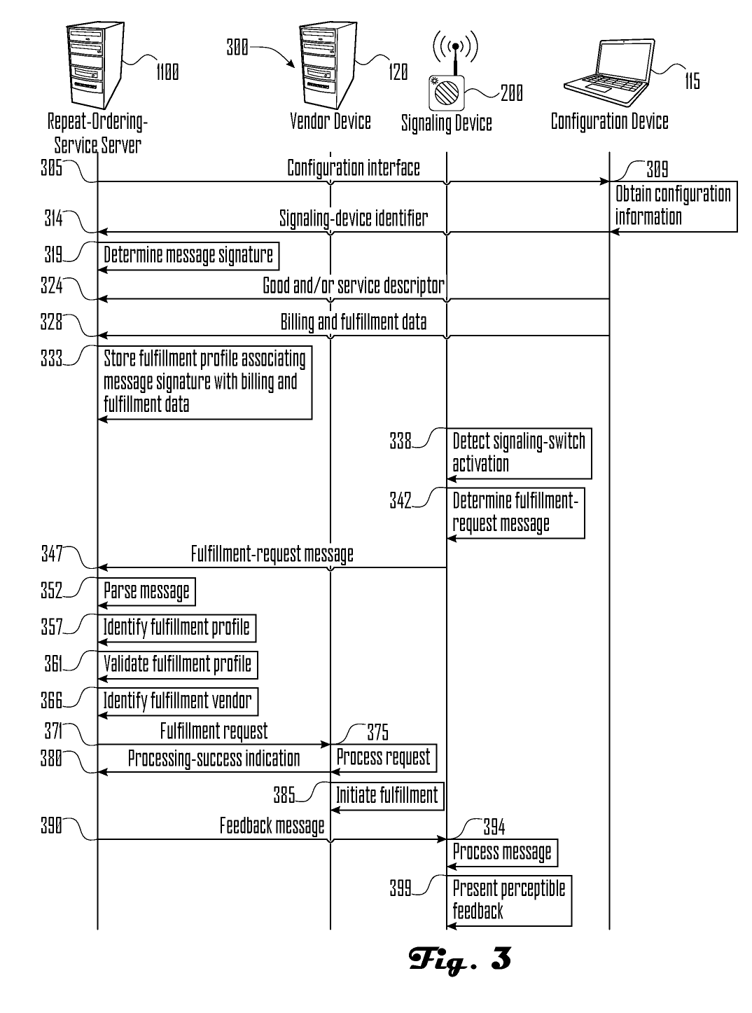

FIG. 3 illustrates an exemplary series of communications between repeat-ordering-service server 1100, vendor device 120, signaling device 200, and configuration device 115 in accordance with one embodiment. The communications shown in FIG. 3 do not encompass every combination of possibilities in which the systems and methods provided herein may be employed. Rather, the illustrated communications merely provide an overview of one simplified example scenario. Additional variations and alternatives are described more fully in the Figures and description that follow.

In the illustrated example, signaling device 200 has only a single signaling switch, which will be configured to initiate fulfillment of a given order for a particular good and/or service, as discussed below.

Beginning the illustrated sequence of communications, repeat-ordering-service server 1100 sends to configuration device 115 a configuration interface 305, such as an HTML document configured to solicit information about signaling device 200 and other information discussed below. configuration device 115 presents configuration interface 305 to an operator and obtains 309 configuration information from the operator.

Having obtained the solicited information, configuration device 115 sends to repeat-ordering-service server 1100 information about signaling device 200, including a signaling-device identifier 314. In one embodiment in which signaling device 200 is configured to communicate with repeat-ordering-service server 1100 via SMS messages over a voice network, signaling-device identifier 314 may include an IMEI number associated with signaling device 200. In other embodiments in which signaling device 200 is configured to communicate with repeat-ordering-service server 1100 via a data network, signaling-device identifier 314 may include a MAC address or other GUID associated with signaling device 200.

Repeat-ordering-service server 1100 determines 319 a message signature that will function to distinguish messages received from a particular signaling switch of signaling device 200 from messages received from other signaling switches of other signaling devices. In the simplified example scenario, signaling device 200 is configured to send only a single message to repeat-ordering-service server 1100, so the message signature may consist solely of the signaling-device identifier 314 previously received. In more complicated scenarios, the message signature may include not only a signaling-device identifier, but also an identifier identifying a particular signaling switch (if signaling device 200 included multiple signaling switches) and/or a particular signaling switch activation modality (if signaling device 200 distinguishes among different activation modes, such as single-press, double-press, long-press, and the like).

Additionally, configuration device 115 uses configuration interface 305 to send to repeat-ordering-service server 1100 information describing a particular good and/or service 324 that should be associated with the signaling-device identifier 314. As discussed above, in various embodiments, signaling device 200 may be configured to order almost any type of consumable good and/or service.

In various embodiments, good and/or service descriptor 324 may describe the good and/or service at varying levels of specificity. For example, in one embodiment, good and/or service descriptor 324 may explicitly identify a product, such as by a Universal Product Code (“UPC”) and/or by a particular vendor's Stock Keeping Unit (“SKU”) code.

In other embodiments, good and/or service descriptor 324 may identify a good and/or service by brand, size, and/or model, e.g., SUPER BABY brand, newborn size, LEAKGUARD model diapers. In still other embodiments good and/or service descriptor 324 identify a good and/or service by other identifiers suitable for distinguishing a particular good and/or service.

In some embodiments, good and/or service descriptor 324 may specify a particular vendor to supply the particular good and/or service. In other embodiments, selecting a vendor may be determined at fulfillment time, as discussed below.

Furthermore, configuration device 115 uses configuration interface 305 to send to repeat-ordering-service server 1100 billing data 328 (e.g., credit card information) and fulfillment data (e.g., a delivery address and/or delivery options).

Repeat-ordering-service server 1100 stores 333 (e.g., in repeat-ordering database 1140) a fulfillment profile associating the message signature determined above with billing and fulfillment data 328.

Meanwhile, signaling device 200 has been positioned by a consumer in a convenient location. At some point thereafter, signaling device 200 detects 338 that the consumer has activated its signaling switch. In response, signaling device 200 determines 342 a fulfillment-request message and sends to repeat-ordering-service server 1100 the fulfillment-request message 347.

Repeat-ordering-service server 1100 parses 352 the message to extract a message signature. using the message signature, repeat-ordering-service server 1100 identifies 357 the previously stored fulfillment profile.

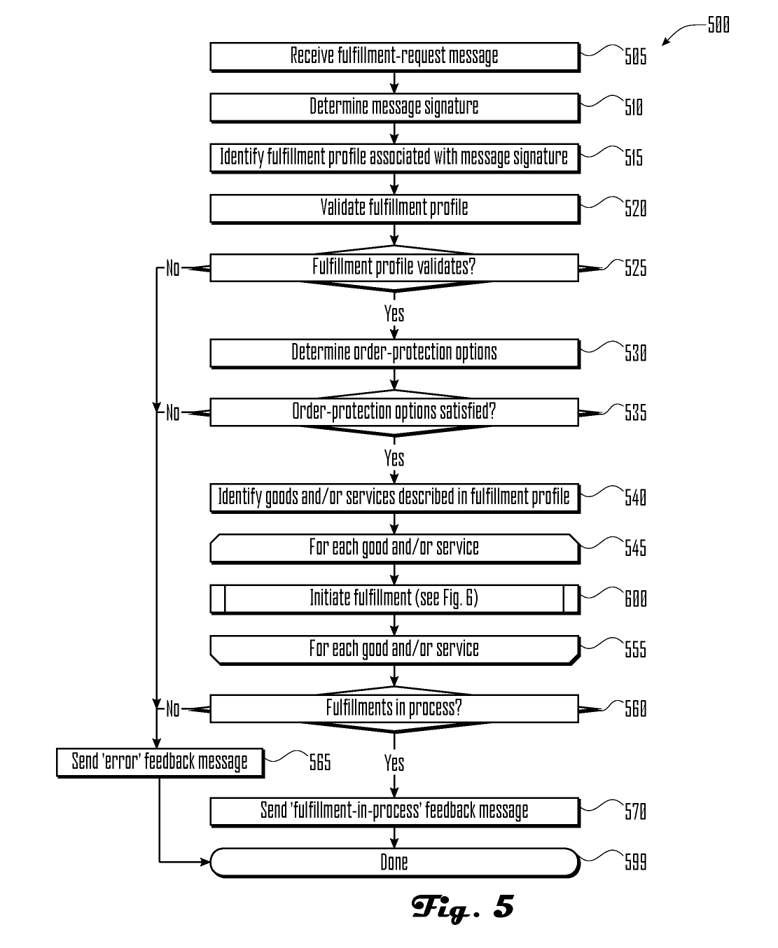

In other scenarios, repeat-ordering-service server 1100 may take various steps to ensure that the fulfillment-request message was sent intentionally prior to initiating fulfillment, as described in connection with block 530 and decision block 535 (see FIG. 5, discussed below). Similarly, in some embodiments, repeat-ordering-service server 1100 may take various steps to decrypt, authenticate, and/or otherwise secure the fulfillment-request message, if the fulfillment-request message was processed by security routine(s) 255 (see FIG. 2, discussed above) before being sent.

However, in the simplified example scenario, repeat-ordering-service server 1100 simply validates 361 the fulfillment profile, such as by determining that the billing information is still valid, determining that the good and/or service are still available, and the like.

Having validated the fulfillment profile, repeat-ordering-service server 1100 identifies 366 a vendor that can provide the good and/or service described in the fulfillment profile. In some embodiments, the fulfillment profile may specify a particular vendor. In other embodiments, the fulfillment profile may specify one or more factors (e.g., price, delivery time, and the like) that may be used to select among several vendors.

Having identified a vendor, repeat-ordering-service server 1100 sends to vendor device 120 a request 371 for the vendor to provide the indicated good and/or service according to the billing information, delivery address, and other fulfillment options specified in the fulfillment profile.

Vendor device 120 processes 375 the request, sends a processing-success indication 380 to repeat-ordering-service server 1100, and initiates 385 the requested fulfillment.

Meanwhile, in response to receiving processing-success indication 380, repeat-ordering-service server 1100 sends to signaling device 200 feedback message 390 indicating that the requested fulfillment has been initiated.

Signaling device 200 processes 394 the message and presents 399 the perceptible feedback to indicate to the consumer that the requested good and/or service are in the process of being fulfilled.

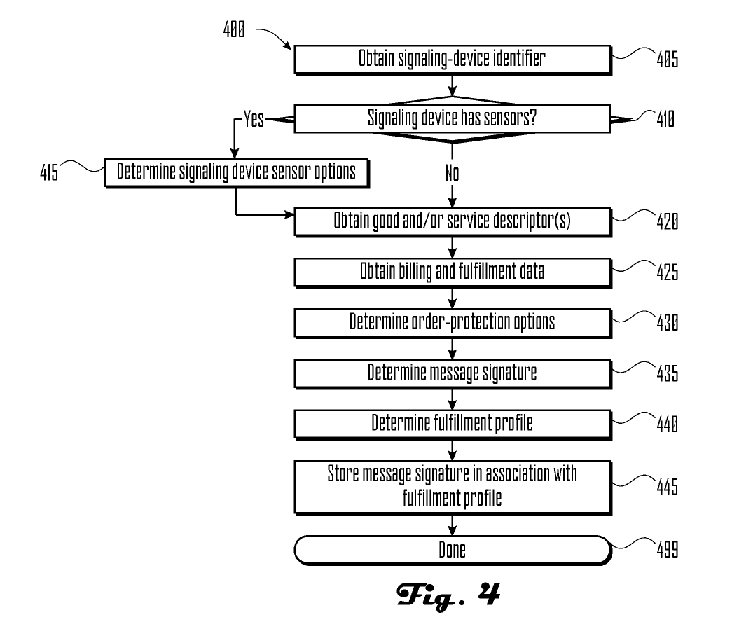

FIG. 4 illustrates a configuration routine 400 for configuring a given signaling switch of a given signaling device to initiate fulfillment of particular goods and/or services, such as may be performed by a repeat-ordering-service server 1100 in accordance with one embodiment.

In some embodiments, configuration routine 400 may be performed multiple times for a given signaling device, if that signaling device has multiple signaling switches and/or multiple signaling-switch activation modes.

In block 405, configuration routine 400 obtains at least one identifier identifying a particular signaling device. In embodiments in which the signaling device is configured to communicate with the repeat-ordering service via SMS messages over a voice network, configuration routine 400 may obtain an IMEI number associated with the signaling device. In other embodiments in which the signaling device is configured to communicate with the repeat-ordering service via a data network, configuration routine 400 may obtain a MAC address or other GUID associated with the signaling device.

In some embodiments, configuration routine 400 may also obtain one or more additional identifiers identifying, for example, a particular signaling switch and/or signaling-switch activation mode (e.g., single-press, double-press, long-press, and the like) of the signaling device.

In decision block 410, configuration routine 400 determines whether the signaling device has one or more sensors. If so, configuration routine 400 proceeds to block 415; otherwise, configuration routine 400 proceeds to block 420.

In block 415, configuration routine 400 determines signaling device sensor options. For example, in one embodiment, if the signaling device is configured with a GPS or other location sensor, configuration routine 400 may determine that the signaling device is so configured and make such location data available for subsequent use in vendor-selection and/or delivery-address determinations.

In block 420, configuration routine 400 obtains at least one descriptor describing at least one particular good and/or service. As discussed above, in various embodiments, a signaling switch of a signaling device may be configured to order almost any type of consumable good and/or service.

In various embodiments, a good and/or-service descriptor may describe the good and/or service at varying levels of specificity. For example, in one embodiment, a good and/or-service descriptor may explicitly identify a product, such as by a UPC and/or by a particular vendor's SKU code.

In other embodiments, a good and/or-service descriptor may identify a good and/or service by brand, size, and/or model, e.g., SUPER BABY brand, newborn size, LEAKGUARD model diapers. In still other embodiments a good and/or-service descriptor identify a good and/or service by other identifiers suitable for distinguishing a particular good and/or service.

In some embodiments, a good and/or-service descriptor may specify a particular vendor to supply the particular good and/or service. In other embodiments, selecting a vendor may be determined at fulfillment time, as discussed below.

In block 425, configuration routine 400 obtains billing data (e.g., credit card information) and/or fulfillment data (e.g., a delivery address or delivery options).

In block 430, configuration routine 400 determines zero or more order-protection options that a repeat-ordering service may use to ensure that accidental fulfillment-request messages are not acted upon. For example, in various embodiments, configuration routine 400 may determine one or more order-protection options similar to some or all of the following.
day and/or time fencing: fulfillment requests only accepted during certain times of day and/or on certain days of the week/month/year;
actions-per-time-period fencing: only a certain count of fulfillment requests are accepted per time period (e.g., N fulfillment requests per day, hour, week, month or the like);
cancellation window: fulfillment requests will not be acted upon if a cancellation message is sent within a certain period of time (e.g., a signaling device may have a signaling switch and/or activation mode configured to cancel a pending request if the cancellation message is sent within, for example, 2 minutes of the fulfillment request);
confirmation window: fulfillment requests are acted upon only after a confirmation signal is received within a certain period of time (e.g., a consumer must activate a confirmation signaling switch and/or activation mode within a certain time period, or the consumer must respond to a SMS or similar text message within a certain time period before a request will be acted upon);
or the like.

For example, in one embodiment, configuration routine 400 may send a message to the signaling device causing the signaling device to present a signal to the user, e.g., by blinking an LED notifying the user to activate a signaling switch to confirm the fulfillment-request message. Once the user provides confirmation (e.g., by activating the signaling switch), the LED is turned off and the order is fulfilled, as discussed further below.

In block 435, configuration routine 400 determines, based at least in part on the signaling-device identifier and zero or more other identifiers obtained in block 405 and optionally on one or more sensor options determined in block 415 (if any), a message signature that will function to distinguish messages received from the given signaling switch of the given signaling device from messages received from other signaling switches of the given signaling device, from other activation modes of the given signaling switch (if any), and from signaling switches of other signaling devices.

In block 440, configuration routine 400 determines a fulfillment profile that associates the message signature determined in block 435 with the order-protection options determined in block 430 (if any) and the good and/or service descriptors obtained in block 420.

In block 445, configuration routine 400 stores (e.g., in repeat-ordering database 1140) the message signature determined in block 435 in association with the fulfillment profile determined in block 440.

Configuration routine 400 ends in ending block 499.

FIG. 5 illustrates a fulfillment-message routine 500 for handling a fulfillment-request message, such as may be performed by a repeat-ordering-service server 1100 in accordance with one embodiment.

In block 435, configuration routine 400 determines, based at least in part on the signaling-device identifier and zero or more other identifiers obtained in block 405 and optionally on one or more sensor options determined in block 415 (if any), a message signature that will function to distinguish messages received from the given signaling switch of the given signaling device from messages received from other signaling switches of the given signaling device, from other activation modes of the given signaling switch (if any), and from signaling switches of other signaling devices.

In various embodiments, the fulfillment-request message may be received in a variety of formats via a variety of communication channels. In one exemplary embodiment, the fulfillment-request message may be received as an SMS message according to the GSM standard.

In various embodiments, the fulfillment-request message may include information similar to some or all of the following.
Device Type (e.g., ‘soft’ application, dedicated hardward apparatus, and the like.)
Device ID (e.g., a GUID)
Action ID (e.g., a indentifier identifying a signaling switch and/or an activation-mode)
Action Info (e.g., sensor data)
Geo-location Data
Timestamp
Sequence number
security signature, password, and/or other encryption, authentication, and/or security-related data that may be generated by security routine(s) 255 (see FIG. 2, discussed above)

In block 510, fulfillment-message routine 500 parses and/or examines metdata associated with the fulfillment-request message received in block 505 to determine a message signature.

Typically, the fulfillment-request message may be associated with various pieces of metadata, such as a sender MSIN or other sender identifier, a time stamp, and the like. In some embodiments, the fulfillment-request message may be associated with additional metadata such as a geo-location associated with the sending device and/or other sensor data reflecting conditions at the sending device.

The metadata associated with and/or the body of the fulfillment-request message may also include one or more signaling switch identifiers and/or signaling-switch activation-mode identifiers.

Generally, the message signature determined in block 510 includes sufficient information to identify a fulfillment profile (e.g., by querying repeat-ordering database 1140) that is associated with a particular signaling device, signaling switch, activation-mode combination.

In block 515, fulfillment-message routine 500 identifies (e.g., by querying repeat-ordering database 1140) a fulfillment profile associated with the message signature determined in block 510. As discussed above, a fulfillment profile generally identifies one or more goods and/or services and includes billing and fulfillment data sufficient to initiate fulfillment of those goods and/or services. In some embodiments, a fulfillment profile may also include one or more order-protection options.

In block 520, fulfillment-message routine 500 validates the fulfillment profile identified in block 515 according to one or more validation criteria. For example, in one embodiment, fulfillment-message routine 500 may determine whether a credit card associated with the fulfillment profile has expired and/or otherwise determine whether the billing data is still valid.

In some embodiments, such as when fulfillment-message routine 500 is performed in connection with a subscription-based repeat-ordering service, fulfillment-message routine 500 may also determine whether a consumer associated with the fulfillment profile is currently in good standing with the repeat-ordering service.

In decision block 525, fulfillment-message routine 500 determines whether the fulfillment profile validates according the one or more validation criteria. If so, fulfillment-message routine 500 proceeds to block 530; otherwise, fulfillment-message routine 500 proceeds to block 565.

In block 530, fulfillment-message routine 500 determines zero or more order-protection options associated with the fulfillment profile identified in block 515. Various exemplary order-protection options are described in connection with block 430 (see FIG. 4, discussed above).

In decision block 535, fulfillment-message routine 500 determines whether the order-protection options determined in block 430 are satisfied. If so, fulfillment-message routine 500 proceeds to block 540; otherwise, fulfillment-message routine 500 proceeds to block 565.

In various embodiments, determining whether the order-protection options are satisfied may include performing operations similar to some or all of the following.
determining whether a time stamp associated with the fulfillment-request message satisfies a date and/or time-based condition specifying when requests are or are not accepted;
accessing a recent request-history to determine whether a count of recent fulfillment requests exceeds a threshold;
waiting for a specified period of time to determine whether a cancellation message is received;
sending a confirmation request to the signaling device that sent the fulfillment-request message and waiting for a specified period of time to determine whether a confirmation message is received;
sending a confirmation request to a mobile phone or other device associated with the fulfillment profile and waiting for a specified period of time to determine whether a confirmation message is received;
or the like.

In block 540, fulfillment-message routine 500 identifies one or more goods and/or services described in the fulfillment profile identified in block 515. beginning in opening loop block 545, fulfillment-message routine 500 processes each good and/or service in turn.

Typically, the fulfillment-request message may be associated with various pieces of metadata, such as a sender MSIN or other sender identifier, a time stamp, and the like. In some embodiments, the fulfillment-request message may be associated with additional metadata such as a geo-location associated with the sending device and/or other sensor data reflecting conditions at the sending device.

In ending loop block 555, fulfillment-message routine 500 iterates back to opening loop block 545 to process the next good and/or service, if any. once all goods and/or services have been processed, in decision block 560, fulfillment-message routine 500 determines whether fulfillment subroutine 600 returned with success conditions. If so, fulfillment-message routine 500 proceeds to block 570; otherwise, fulfillment-message routine 500 proceeds to block 565.

When fulfillment-message routine 500 determines that the fulfillment profile does not validate, that one or more order-protection options are not satisfied, or that one or more of the good and/or service could not be fulfilled, then in block 565, fulfillment-message routine 500 sends one or more ‘error’ feedback messages to the signaling device that sent the fulfillment-request message and/or to a mobile phone or other device associated with the fulfillment profile.

When fulfillment-message routine 500 determines in decision block 560 that fulfillment subroutine 600 returned with success conditions, then in block 570, fulfillment-message routine 500 sends a ‘fulfillment-in-process’ feedback message to the signaling device that sent the fulfillment-request message and/or to a mobile phone or other device associated with the fulfillment profile identified in block 515.

Once each good and/or service has been processed, fulfillment-message routine 500 ends in ending block 599.

In some embodiments, such as when fulfillment-message routine 500 is performed in connection with a subscription-based repeat-ordering service, fulfillment-message routine 500 may also determine whether a consumer associated with the fulfillment profile is currently in good standing with the repeat-ordering service.

In block 605, fulfillment subroutine 600 determines a fulfillment destination for the given good and/or service. In some embodiments, the given fulfillment profile may specify a fixed fulfillment destination.

In other embodiments, the fulfillment destination may be dynamically determined based on one or more destination-selection factors specified in the given fulfillment profile. For example, in one embodiment, the given fulfillment profile may specify that different fulfillment destinations be used at different specified dates, days, and/or times.

In other embodiments, the given fulfillment profile may specify that a fulfillment destination is determined based on a current geo-location of the signaling device that sent the fulfillment-request message, as specified in or otherwise associated with the fulfillment-request message. In other embodiments, the given fulfillment profile may specify other types of destination-selection factors.

In block 610, fulfillment subroutine 600 identifies a fulfillment vendor to provide the given good and/or service. In some embodiments, the fulfillment vendor may be specified in the given fulfillment profile. In other embodiments, the given fulfillment profile may specify one or more vendor-selection factors that may be used to select among two or more competing fulfillment vendors.

For example, in some embodiments, the given fulfillment profile may specify a price-based vendor-selection factor, such that a fulfillment vendor that can currently provide the given good and/or service to the determined fulfillment destination at a lower price may be favored over higher-priced fulfillment vendors.

Similarly, in some embodiments, the given fulfillment profile may specify a fulfillment-time-based vendor-selection factor, such that a fulfillment vendor that can complete fulfillment of the given good and/or service to the determined fulfillment destination more quickly may be favored over slower fulfillment vendors.

In other embodiments, the given fulfillment profile may specify other types of vendor-selection factors.

In decision block 615, fulfillment subroutine 600 determines whether a fulfillment vendor was identified in block 610. If so, fulfillment subroutine 600 proceeds to block 620; otherwise, fulfillment subroutine 600 iterates back to ending block 699.

When fulfillment subroutine 600 determines that no fulfillment vendor can be identified to fulfill the given good and/or service, then in ending block 699, fulfillment subroutine 600 ends, returning to the caller with an ‘error’ condition.

In block 620, fulfillment subroutine 600 sends to the fulfillment vendor identified in block 610 a message requesting that the fulfillment vendor initiate fulfillment of the given good and/or service according to billing and/or fulfillment data specified in the given fulfillment profile.

In decision block 625, fulfillment subroutine 600 determines whether the fulfillment vendor sends a message or otherwise confirms that it received the fulfillment request and will initiate fulfillment of the given fulfillment profile. If so, fulfillment subroutine 600 proceeds to ending block 698; otherwise, fulfillment subroutine 600 iterates back to block 610.

When the fulfillment vendor confirms that it will fulfill the given good and/or service, fulfillment subroutine 600 ends in ending block 698, returning to the caller with a ‘fulfillment-in-process’ condition.

FIG. 7 illustrates a signaling routine 700 for sending a fulfillment-request message to a repeat-ordering service, such as may be performed by a signaling device 200 in accordance with one embodiment.

Signaling routine 700 depicts a simplified ‘run loop’ that iterates from opening loop block 705 to ending loop block 745 while a typical signaling device is powered and functioning normally. in many embodiments, a signaling device may spend most of its time in a ‘standby’ or low-power state. Consequently, in block 710, signaling routine 700 enters a ‘standby’ state in which the signaling device may poll for activity (e.g., a signaling switch activation and/or a feedback message receipt) without consuming a large amount of power. In some embodiments, entering a low-power state may include activating a ‘standby’ battery and disconnecting a main battery from powering a main bus.

In decision block 715, signaling routine 700 determines whether one of one or more signaling switches of the signaling device has been activated, typically by a consumer, via one of one or more activation modes. If so, signaling routine 700 proceeds to switch-handling subroutine 800; otherwise, signaling routine 700 proceeds to decision block 725.

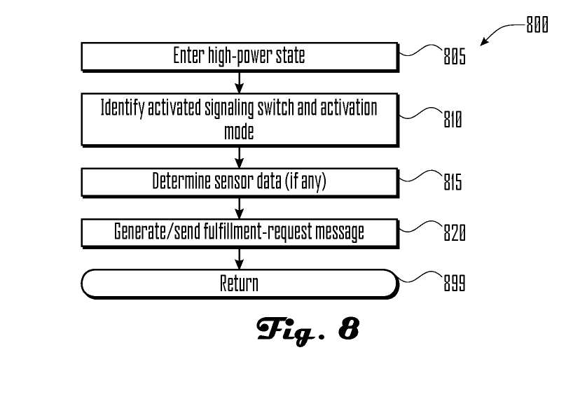

In subroutine block 800, signaling routine 700 calls subroutine 800 (see FIG. 8, discussed below) to handle the determined activation of the one of more signaling switches.

In decision block 725, signaling routine 700 determines whether a feedback message has been received, typically from a pre-configured repeat-ordering server (e.g., repeat-ordering-service server 1100). If so, signaling routine 700 proceeds to feedback-message-handling subroutine 900; otherwise, signaling routine 700 proceeds to decision block 735.

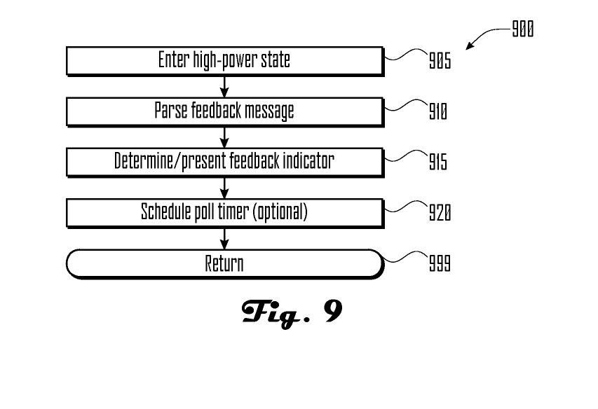

In subroutine block 900, signaling routine 700 calls subroutine 900 (see FIG. 9, discussed below) to handle the recieved feedback message.

In decision block 735, signaling routine 700 determines whether a polling timer (if any) has expired. If so, signaling routine 700 proceeds to timer-expiration subroutine 1000; otherwise, signaling routine 700 proceeds to ending loop block 745.

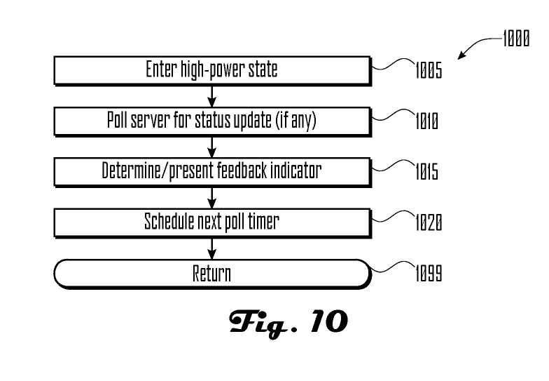

In subroutine block 1000, signaling routine 700 calls subroutine 1000 (see FIG. 10, discussed below) to handle the expiration of the timer.

In ending loop block 745, signaling routine 700 iterates back to opening loop block 705 if it is still polling for activity. when the signaling device is no longer actively polling for activity (e.g. because the signaling device has been switched to an inactive state), signaling routine 700 ends in ending block 799.

FIG. 8 illustrates a switch-handling subroutine 800 for handling activation of a signaling switch, such as may be performed by a signaling device 200 in accordance with one embodiment.

In block 805, switch-handling subroutine 800 enters a temporary ‘active’ or high-power power state, if the signaling device is not already in such a state. In some embodiments, entering a high-power state may include connecting a main battery to power a main bus. In various embodiments, a signaling device may have more than one high-power and/or low-power state. For example, in one embodiment, a signaling device may have a first high-power state in which a processor is running at normal speed, but the device is not on a network, and a second high-power state in which the device is also on a network.

In block 810, switch-handling subroutine 800 determines, e.g. by consulting one or more identifiers 260 (see FIG. 2, discussed above), one or more identifiers associated with the signaling device itself, the signaling switch that was activated, and/or an activation mode of the activated signaling switch.

If the signaling device includes one or more optional sensors, in block 815, switch-handling subroutine 800 determines current data associated with the one or more sensors.

In block 820, switch-handling subroutine 800 uses the one or more identifiers determined in block 810 and any sensor data determined in block 815 to generate a fulfillment-request message and send to a pre-configured repeat-ordering server (e.g., repeat-ordering-service server 1100) the fulfillment-request message thereby generated, notifying the repeat-ordering service that the signaling switch has been activated according to the determined activation mode.

Switch-handling subroutine 800 ends in ending block 899, returning to the caller.

FIG. 9 illustrates a feedback-message-handling subroutine 900 for handling a received feedback message, such as may be performed by a signaling device 200 in accordance with one embodiment.

In block 905, feedback-message-handling subroutine 900 enters a temporary ‘active’ or high-power power state, if the signaling device is not already in such a state. In some embodiments, entering a high-power state may include connecting a main battery to power a main bus.

In block 910, feedback-message-handling subroutine 900 parses the feedback message. in block 915, feedback-message-handling subroutine 900 determines an appropriate feedback indicator and presents the determined appropriate feedback indicator, e.g. by activating feedback-presentation component 215 (see FIG. 2, discussed above).

For example, in one embodiment when the signaling device includes a feedback-presentation component such as one or more LEDs, feedback-message-handling subroutine 900 may determine to light a first LED when a ‘fulfillment-in-process’ feedback message is received, but to light a second LED when an ‘error’ feedback message is received. Alternately, in some embodiments, feedback-message-handling subroutine 900 may determine to blink an LED according to a first blink pattern when a ‘fulfillment-in-process’ feedback message is received, but to blink the LED according to a second blink pattern when an ‘error’ feedback message is received.

In decision block 715, signaling routine 700 determines whether one of one or more signaling switches of the signaling device has been activated, typically by a consumer, via one of one or more activation modes. If so, signaling routine 700 proceeds to switch-handling subroutine 800; otherwise, signaling routine 700 proceeds to decision block 725.

In other embodiments, feedback-message-handling subroutine 900 may determine to present feedback according to a method that is suitable for the type or types of feedback components that the signaling device is configured to use.

In some embodiments, if the feedback message indicates that an order remains pending, in block 920, feedback-message-handling subroutine 900 determines an appropriate period of time to wait before polling the server again and schedules a timer to expire after that period of time.

Feedback-message-handling subroutine 900 ends in ending block 999, returning to the caller.

FIG. 10 illustrates a timer-expiration subroutine 1000 for handling an expired timer, such as may be performed by a signaling device 200 in accordance with one embodiment.

In block 1005, timer-expiration subroutine 1000 enters a temporary ‘active’ or high-power power state, if the signaling device is not already in such a state. In some embodiments, entering a high-power state may include connecting a main battery to power a main bus.

In block 1010, timer-expiration subroutine 1000 polls the server for status update (if any). in block 1015, timer-expiration subroutine 1000 determines an appropriate feedback indicator based on any status update received in block 1010 and presents the determined feedback indicator, e.g. by activating feedback-presentation component 215 (see FIG. 2, discussed above).

If the status update obtained in block 1010 indicates that an order remains pending, in some embodiments, in block 1020, timer-expiration subroutine 1000 determines an appropriate period of time to wait before polling the server again and schedules a timer to expire after that period of time.

Timer-expiration subroutine 1000 ends in ending block 1099, returning to the caller.

FIG. 11 illustrates several components of an exemplary repeat-ordering-service server in accordance with one embodiment. In various embodiments, repeat-ordering-service server 1100 may include a desktop PC, server, workstation, mobile phone, laptop, tablet, set-top box, appliance, or other computing device that is capable of performing operations such as those described herein. In some embodiments, repeat-ordering-service server 1100 may include many more components than those shown in FIG. 11. However, it is not necessary that all of these generally conventional components be shown in order to disclose an illustrative embodiment.

In various embodiments, repeat-ordering-service server 1100 may comprise one or more physical and/or logical devices that collectively provide the functionalities described herein. In some embodiments, repeat-ordering-service server 1100 may comprise one or more replicated and/or distributed physical or logical devices.

In block 820, switch-handling subroutine 800 uses the one or more identifiers determined in block 810 and any sensor data determined in block 815 to generate a fulfillment-request message and send to a pre-configured repeat-ordering server (e.g., repeat-ordering-service server 1100) the fulfillment-request message thereby generated, notifying the repeat-ordering service that the signaling switch has been activated according to the determined activation mode.

Repeat-ordering-service server 1100 includes a bus 1105 interconnecting several components including a network interface 1110, an optional display 1115, a central processing unit 1120, and a memory 1125.

Memory 1125 generally comprises a random access memory (“RAM”) and permanent non-transitory mass storage device, such as a hard disk drive or solid-state drive. Memory 1125 stores program code for a configuration routine 400 for configuring a given signaling switch of a given signaling device to initiate fulfillment of particular goods and/or services (see FIG. 4, discussed above) and a fulfillment-message routine 500 for handling a fulfillment-request message (see FIG. 5, discussed above). In addition, the memory 1125 also stores an operating system 1135.

These and other software components may be loaded into memory 1125 of repeat-ordering-service server 1100 using a drive mechanism (not shown) associated with a non-transitory computer-readable medium 1130, such as a floppy disc, tape, DVD/CD-ROM drive, memory card, or the like.

Memory 1125 also includes repeat-ordering database 1140. In some embodiments, repeat-ordering-service server 1100 may communicate with repeat-ordering database 1140 via network interface 1110, a storage area network (“SAN”), a high-speed serial bus, and/or via the other suitable communication technology.

In some embodiments, repeat-ordering database 1140 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Although specific embodiments have been illustrated and described herein, it will be appreciated by those of ordinary skill in the art that alternate and/or equivalent implementations may be substituted for the specific embodiments shown and described without departing from the scope of the present disclosure. For example, in some embodiments, instead or or in addition to the configuration process described in configuration routine 400 (see FIG. 4, discussed above), a repeat-ordering system may record configuration information about a signaling device via manual input, with such information being provided to an operative by a consumer via a voice call; paper form; text, audio, and/or video messaging, or the like. This application is intended to cover any adaptations or variations of the embodiments discussed herein.

### DRAWINGS

Not Applicable.

What is claimed is:

1. A consumer-operated dedicated order-signaling device, comprising:
a uniquely identifiable signaling switch;
a signaling-device memory storing a particular switch identifier that is associated with said uniquely identifiable signaling switch; and
a wireless network interface configured to transmit a first fulfillment message, including said particular switch identifier, to a repeat-ordering-service server when said uniquely identifiable signaling switch is manually activated by a consumer according to a first activation action.

2. The consumer-operated dedicated order-signaling device of claim 1, wherein upon receipt of said first fulfillment message from the dedicated order-signaling device:
said repeat-ordering-service server identifies a pre-defined fulfillment profile as being associated with said particular switch identifier; and
said repeat-ordering-service server initiates fulfillment of at least one particular good and/or service, as identified by said pre-defined fulfillment profile, from a fulfillment vendor to a fulfillment destination corresponding to the dedicated order-signaling device without further communication or interaction between said consumer and said fulfillment vendor.

3. The consumer-operated dedicated order-signaling device of claim 2, further comprising a feedback-presentation component configured for presenting feedback messages from said repeat-ordering-service server.

4. The consumer-operated dedicated order-signaling device of claim 2, wherein said dedicated order-signaling device is physically configured to be placed in a location that is near to where said consumer would typically become aware of a need to order said at least one particular good and/or service.

5. The consumer-operated dedicated order-signaling device of claim 4, wherein said dedicated order-signaling device is further physically configured as a single button.

6. The consumer-operated dedicated order-signaling device of claim 1, wherein said wireless network interface is further configured to transmit a second fulfillment message when said uniquely identifiable signaling switch is manually activated by said consumer according to a second activation action.

7. The consumer-operated dedicated order-signaling device of claim 1, wherein said wireless network interface is reconfigurable to transmit a second fulfillment message when said uniquely identifiable signaling switch is manually activated by said consumer according to said first activation action.

8. The consumer-operated dedicated order-signaling device of claim 1, further comprising a second uniquely identifiable signaling switch.

9. The consumer-operated dedicated order-signaling device of claim 8, wherein said wireless network interface is further configured to transmit a second fulfillment message when said second uniquely identifiable signaling switch is manually activated by said consumer.

10. The consumer-operated dedicated order-signaling device of claim 1, further comprising a sensor, and wherein said first fulfillment message further comprises sensor-input data.

11. The consumer-operated dedicated order-signaling device of claim 10, wherein said sensor is selected from a temperature sensor, a geolocation sensor, a microphone, a photodetector, and a motion sensor.

12. An order-fulfillment system comprising:
a repeat-ordering-service server comprising:
a server network interface; and
a memory storing a plurality of pre-defined fulfillment profiles, each being associated with a switch identifier, and each identifying at least a good and/or service, billing data, and a fulfillment destination; and
a consumer-operated dedicated order-signaling device, comprising:
a uniquely identifiable signaling switch;
a signaling-device memory storing a particular switch identifier that is associated with said uniquely identifiable signaling switch; and
a device network interface configured to transmit a fulfillment message, including said particular switch identifier, to said repeat-ordering-service server when said uniquely identifiable signaling switch is activated;
wherein upon receipt of said fulfillment message from said dedicated order-signaling device, said repeat-ordering-service server:
identifies a particular fulfillment profile as being associated with said particular switch identifier;
validates said particular fulfillment profile; and
when said particular fulfillment profile is validated, initiates fulfillment of a particular good and/or service identified by said particular fulfillment profile.

13. The order-fulfillment system of claim 12, wherein said dedicated order-signaling device is physically configured to be placed in a locale that is near to where a consumer would typically become aware of a need for the particular good and/or service.

14. The order-fulfillment system of claim 12, wherein said device network interface comprises a wireless network interface.

15. The order-fulfillment system of claim 14, wherein said wireless network interface is compatible with a cellular communication protocol selected from Global System for Mobile Communications (“GSM”), code division multiple access (“CDMA”), and Long-Term Evolution (“LTE”).

16. A repeat-ordering-service-server-implemented method for handling a fulfillment-request message, the method comprising:
receiving, by the repeat-ordering-service server, said fulfillment-request message;
determining, by the repeat-ordering-service server based at least in part on metdata associated with said fulfillment-request message, a message signature distinguishing said fulfillment-request message as having been sent by a particular remote signaling device;
identifying, by the repeat-ordering-service server, a fulfillment profile associated with said message signature, said fulfillment profile indicating at least a particular good and/or service, delivery data, and billing data;
validating, by the repeat-ordering-service server, said fulfillment profile according to one or more validation criteria; and
when said fulfillment profile validates:
identifying, by the repeat-ordering-service server, said particular good and/or service described in said fulfillment profile; and
initiating, by the repeat-ordering-service server, fulfillment of said particular good and/or service.

17. The method of claim 16, further comprising sending a feedback message to said particular remote signaling device indicating a fulfillment status.

18. The method of claim 16, further comprising:
determining an order-protection option for distinguishing between purposeful and accidental activations of said particular remote signaling device; and
confirming that said order-protection option is satisfied prior to initiating fulfillment of said particular good and/or service.

19. The method of claim 16, wherein initiating fulfillment of said particular good and/or service comprises:
determining a fulfillment destination;
identifying a fulfillment vendor; and
sending to said fulfillment vendor a fulfillment request to provide said particular good and/or service at said fulfillment destination.

20. A computing apparatus comprising a processor and a memory having stored thereon instructions that, when executed by the processor, configure the computing apparatus to perform the method of claim 16.

21. A non-transitory computer-readable storage medium having stored thereon instructions including instructions that, when executed by a processor, configure the processor to perform the method of claim 16.

22. A repeat-ordering-service-server-implemented method for configuring a remote signaling device to initiate fulfillment of a particular good and/or service, the method comprising:
obtaining, by the repeat-ordering-service server, a signaling-device identifier identifying said remote signaling device;
obtaining, by the repeat-ordering-service server, a good and/or service descriptor identifying said particular good and/or service;
obtaining, by the repeat-ordering-service server, delivery data specifying at least a fulfillment destination to which said particular good and/or service should be delivered when said remote signaling device is activated;
obtaining, by the repeat-ordering-service server, billing data specifying at least a payment method for paying for said particular good and/or service when said remote signaling device is activated;
determining, by the repeat-ordering-service server based at least in part on said signaling-device identifier, a message signature for distinguishing fulfillment messages sent to the repeat-ordering-service server by said remote signaling device;
determining, by the repeat-ordering-service server, a fulfillment profile corresponding to said good and/or service descriptor, said delivery data, and said billing data; and
storing, by the repeat-ordering-service server, said message signature in association with said fulfillment profile.

23. The method of claim 22, further comprising:
determining an order-protection option for distinguishing between purposeful and accidental activations of said remote signaling device; and
wherein said fulfillment profile further corresponds to said order-protection option.

24. The method of claim 23, wherein said order-protection option comprises at least one of a day and/or time fence, an actions-per-time-period fence, a cancellation window, and a confirmation window.

25. A signaling-device-implemented method for sending a fulfillment-request message to a repeat-ordering service, the method comprising:
while in a low-power state, detecting, by said signaling device, that a uniquely identifiable signaling switch has been activated, and in response:
temporarily entering a high-power state;
generating, by said signaling device, said fulfillment-request message; and
sending, by said signaling device, said fulfillment-request message to a predetermined repeat-ordering server, thereby notifying said repeat-ordering service that the uniquely identifiable signaling switch has been activated.

26. The method of claim 25, wherein generating said fulfillment-request message comprises:
determining a current location associated with said signaling device; and
incorporating said current location into said fulfillment-request message.

27. The method of claim 25, wherein generating said fulfillment-request message comprises:
determining a current environmental aspect associated with said signaling device; and
incorporating said current environmental aspect into said fulfillment-request message.

28. The method of claim 25, further comprising, while in said low-power state, detecting that a feedback message has been received from said repeat-ordering service, and in response:
temporarily entering said high-power state;
parsing said feedback message to determine an appropriate feedback indicator; and
presenting said appropriate feedback indicator via a feedback component.

29. The method of claim 28, further comprising, when said feedback message indicates that an order remains pending:
scheduling a subsequent poll of said repeat-ordering service after a determined period of time.

30. The method of claim 25, further comprising activating a standby battery and disconnecting a main battery from powering a main bus to re-enter said low-power state.
